(19) United States
(12) Patent Application Publication
(10) Pub. No.: US 2014/0186133 A1
(43) Pub. Date: Jul. 3, 2014

(54) JOINT CONNECTION BETWEEN TWO COMPONENTS, RIVET SLEEVE AND BLIND RIVET FOR SUCH A JOINT CONNECTION AND METHOD FOR PRODUCING SUCH A JOINT CONNECTION

(71) Applicant: RICHARD BERGNER VERBINDUNGSTECHNIK GMBH & CO. KG, (US)

(72) Inventor: Klaus Dehlke, Windsbach (DE)

(73) Assignee: RICHARD BERGNER VERBINDUNGSTECHNIK GMBH & CO. KG, SCHWABACH (DE)

(21) Appl. No.: 13/728,007

(22) Filed: Dec. 27, 2012

(51) Int. Cl. F16B 19/10

(52) U.S. Cl. CPC F16B 19/1036
USPC 411/43

(57) ABSTRACT

In order to form a reliable blind rivet connection in the case of a joined connection between two components having at least one laminate component, without the risk of delamination of the laminate component, a two-layer structure of the rivet sleeve of the blind rivet is provided. The inner layer is formed in this case of a higher strength material, in particular of stainless steel. The outer layer is formed of a softer material, in particular plastics material.

The invention relates to a joined connection between two components, in particular for a motor vehicle, at least one of which components consists of a fiber-reinforced plastics material. The invention also relates to a blind rivet for such a joined connection.

On account of the desired lightweight construction, in particular in the motor vehicle sector, efforts are being made to use fiber composite materials in motor vehicles, said fiber composite materials having very good mechanical properties alongside a low specific weight. Compared with steel sheets that are currently still conventionally used in mass production, such fiber composite materials, for example CFRP components, can be fastened to one another or to other components only with a large amount of effort. On account of the high degree of automation in the automotive industry, a joining process has to allow a high process rate and furthermore also be fault-tolerant with regard to adjustment inaccuracies of the components to be joined.

Taking this as a departure point, the invention is based on the object of making possible a joined connection between two components, in particular components for the motor vehicle sector, wherein at least one of the components is a fiber composite material component.

The object is achieved according to the invention by a joined connection having the features of claim 1, and by a rivet sleeve having the features of claim 15 and by a blind rivet for such a joined connection.

Preferred developments are set out in the dependent claims. The object is furthermore achieved according to the invention by a rivet sleeve and by a blind rivet according to the further independent claims.

Accordingly, it is provided that the rivet sleeve has a multilayer, in particular two-layer, structure, at least in the region of the sleeve shank, wherein the two layers are formed from materials having different strengths and the outer layer in abutment against the components to be connected consists of a material of lower strength. Further layers are preferably not provided, and therefore the rivet sleeve is formed with a total of two layers.

Thus, compared with the inner layer, the outer layer is formed in a much softer manner, so that only comparatively small forces are exerted on the components, in particular on the edges at the periphery of the hole, during the setting operation. As a result, damage to the fiber-reinforced component, in particular what is known as delamination, is avoided during the setting operation. The at least one fiber-reinforced component is formed in particular as a carbon-fiber-reinforced component (CFRP component). This plastics component is in this case in particular a laminate component which is constructed from a plurality of laminate layers.

Therefore, the outer layer forms as it were a protective layer for the components. At the same time, sufficient strength of the rivet sleeve as a whole is achieved by the higher strength inner layer of the rivet sleeve. On account of the division into two different layers, the properties of the rivet sleeve can therefore be adapted optimally to different, sometimes contradictory requirements.

Preferred configurations of the rivet sleeve can be gathered from the dependent claims.

Accordingly, it is in particular provided that the inner layer consists of a preferably corrosion-resistant metal, in particular from stainless steel. The strength of the rivet sleeve can—in particular given the same wall thickness—be set in desired ranges by heat treatment (hardening), so that a rivet sleeve having the same dimensions but different strengths can be employed for different applications (strength requirements).

The outer layer consists preferably of a plastics material, in particular an unreinforced plastics material such as polyamide or the like, for example.

The inner layer has preferably a much higher strength than the outer layer, with the strengths differing here in particular by a multiple, at least by 2 to 5 times.

Expediently, different wall thicknesses for the different layers are furthermore also provided, wherein in particular the inner layer has a much smaller wall thickness. The wall thickness of the inner layer is in this case preferably less than 0.5 mm and is in particular below 0.2 mm or 0.1 mm.

By contrast, the outer layer expediently has a wall thickness >0.5 mm, in particular >0.75 mm or even >1 mm. On account of the comparatively thick wall thickness, reliable protection of the components is ensured.

The outer layer is in this case formed in particular in the manner of an encapsulated casing, i.e. the outer layer is expediently applied in a plastics injection-molding process. The outer layer is in this case formed in particular on the rivet sleeve. Preferably, it extends over the entire sleeve, is thus also formed on the underside of the snap head of the rivet sleeve and thus rests with the outer layer flat against the upper component of the joined connection.

Furthermore, sealing via the rivet sleeve preferably takes place via the outer layer of the sleeve, which is softer compared with the components, and so the rivet connection as a whole connects the components in a sealing manner. The sealing action is achieved by the softer sleeve, which as a result molds itself to the harder components in particular by elastic or plastic deformation during the setting operation.

The blind rivet is in this case preferably corrosion-resistant and furthermore at least the outer layer of the rivet sleeve is electrically insulating. In particular in the case of a preferred mixed connection of components made of different materials, i.e. in particular in the case of a connection of a metal component, for example an aluminum or steel sheet, to the CFRP component, electrical insulation of the two components from one another is essential, in order to prevent corrosion of the metal component.

In an expedient development, the inner layer is widened or bent open at the end of the sleeve shank, thereby forming an approximately funnel-shaped sleeve opening. This is of particular significance for the setting operation, since a rivet mandrel can be guided reliably via this funnel-like opening. This ensures in particular that the setting forces transmitted via the rivet mandrel to the rivet sleeve are introduced reliably.

In spite of the conical widening of the inner layer, the outside diameter of the sleeve shank of the rivet sleeve remains preferably constant, i.e. the rivet sleeve as such does not widen at the shank-side end. Therefore, the sleeve shank has a constant outside diameter along its entire length.

The inner layer is preferably guided in the widened end region up to the maximum outside diameter of the rivet sleeve, and therefore forms at the extreme end of the sleeve shank the outer end periphery of the rivet sleeve.

The opening angle of the widened region, i.e. the angle at which the widened region is oriented with respect to a center longitudinal axis of the sleeve shank, is preferably in a range between 30° and 60° and in particular in the region of 45°.

In the production of motor vehicle components, the usual procedure nowadays is that the entire vehicle body is dipped in a bath in order to apply a protective paint, namely in what is known as a CDP (cathodic dip painting) bath. In this bath there prevails a temperature in the range of about 180 to 190° C. The vehicle body is dipped therein approximately for a half-hour. The blind rivet has to be correspondingly heat-resistant in order to withstand this load.

The two components are preferably adhesively bonded together over their entire surface with the aid of an adhesive. The adhesive is in this case a thermally curing adhesive. The curing takes place preferably in the CDP bath.

The blind rivets, via which the two components are connected together, therefore serve for fixing the two components to one another until the adhesive has cured.

In addition, the blind rivets also make a contribution to the solidity of the joined connection in the finished joined connection. This applies in particular to forces that occur in the axial direction, i.e. perpendicularly to the component surfaces. The forces parallel to the connecting plane between the two components are usually already absorbed very well via the adhesive connection, especially since CFRP components have, as typically laminated components, a fabric impregnated with synthetic resin, said fabric preferably being loadable in all spatial directions in the same way.

The rivet mandrel has preferably greater strength than the rivet sleeve. In particular, it consists of stainless steel. In principle, a rivet mandrel made of steel can also be used. However, in this case, there is the problem of corrosion under certain circumstances, in particular of the breaking point of the residual mandrel after the setting operation.

In general, the blind rivet is preferably formed such that a bearing surface that is as large as possible is formed both on the snap head side and on the closing head side, in order to keep the surface pressure force per unit area small, in order to avoid damage to the CFRP component as far as possible.

In an expedient configuration, it is provided to this end that the wall of the rivet sleeve to be deformed via the mandrel head is comparatively large. Thus, a comparatively thick-walled rivet sleeve is used in order to achieve a closing head that is as wide as possible. The comparison relates in this case to conventional steel rivets. In particular, it is provided in this case that the wall thickness of the rivet sleeve is very large compared with the diameter of the rivet mandrel and is, for example, at least 70% of the diameter of the residual mandrel and going beyond this for example greater than the diameter of the residual mandrel.

In order to allow fault-tolerant, automated joining at a high cycle rate, it is provided in particular that the upper component, assigned to the snap head, has a larger hole diameter than the (CFRP) component located underneath. As a result, positional inaccuracies of the two components oriented with respect to one another are compensated without problems, without shear forces acting on the blind rivet.

Expediently, it is furthermore provided that the remaining free space between the rivet sleeve and the wall of the hole in the upper part is filled with an adhesive, as is described for example in DE 10 2008 026 356 A1.

The components are usually prepunched components, in which the holes are positioned so as to be aligned as far as possible over one another.

Therefore, in order to form the joined connection, the procedure is generally carried out such that the curable adhesive is applied to the entire surface of at least one of the components, with subsequently the second component being positioned in as accurate a position as possible with respect to the first component so that the holes for the blind rivets are aligned as far as possible with one another. Subsequently, the blind rivets are plugged into the respective through-holes and set by way of the usual blind rivet setting operation. To this end, a setting tool is used to pull the rivet mandrel in the axial direction so that the mandrel head is pulled into the rivet sleeve and the latter is in the process deformed to form the closing head. The rivet mandrel snaps off at a predetermined breaking point when a predefined setting force is reached, said predetermined breaking point usually being arranged in the interior of the rivet sleeve, so that a residual mandrel remains in the rivet sleeve. Subsequently, the joined-together components, which may in particular also be part of a complex component, for example a whole vehicle body, are dipped into a hot CDP bath and subjected to painting there. During this treatment, the thermally curing adhesive cures fully between the components to be joined.

The setting operation takes place in an automated manner, in particular a fully automated manner, for example within a production line and by way of a blind rivet robot (as is described for example in WO2006/056255 A1), which travels automatically to the required position and carries out the setting operation fully automatically.

Exemplary embodiments of the invention are explained in more detail in the following text with reference to the figures, in which:

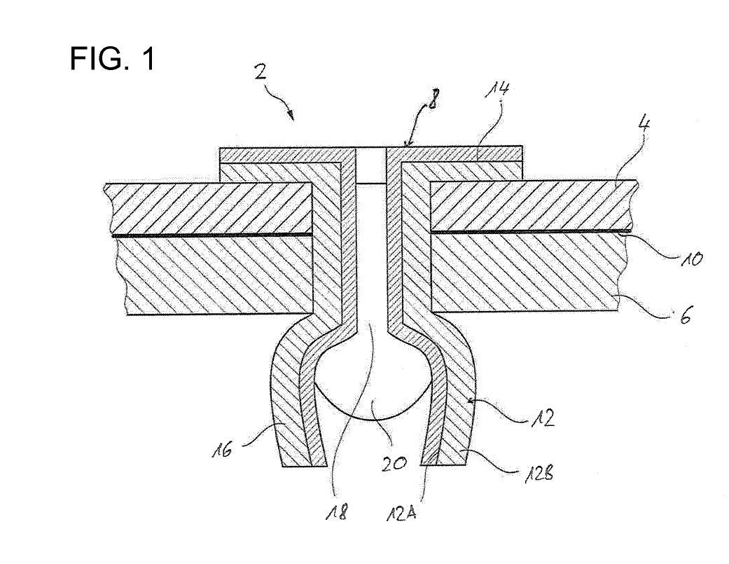

FIG. 1 shows a schematic illustration of a cross section through a joined connection between two components using a blind rivet having a multilayer rivet sleeve,

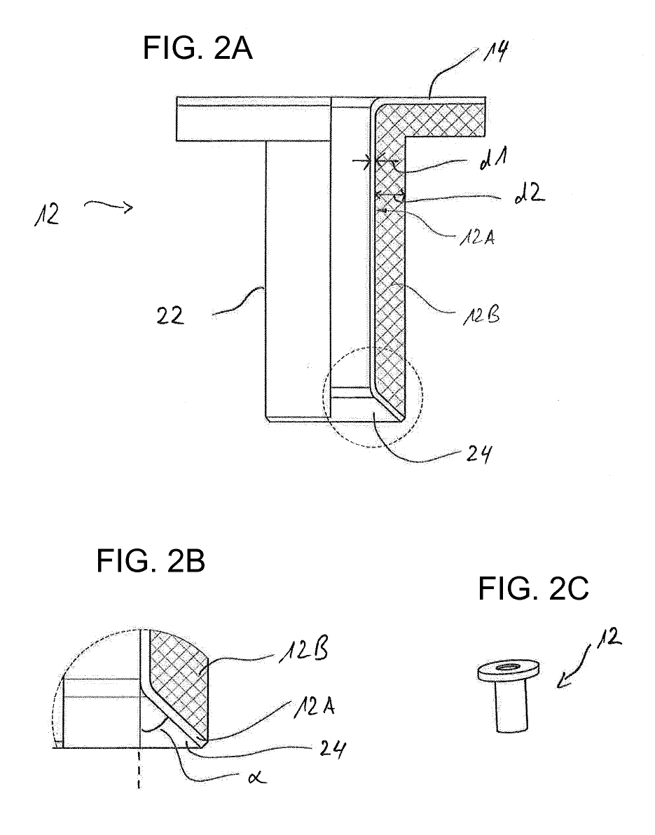

FIG. 2a shows a partially sectional side illustration of a multilayer rivet sleeve according to the invention,

FIG. 2b shows an enlarged illustration of the region indicated with a circle in FIG. 2a,

FIG. 2c shows a perspective view of the rivet sleeve according to FIG. 2a.

In the figures, equivalent parts are provided with the same reference signs.

In the joined connection 2 illustrated in FIG. 1, two components 4, 6 are connected together with the aid of a blind rivet 8. The components 4, 6 are preferably motor vehicle components, in particular metal sheet-like, large-surface-area components. At least one of the two components 4, 6, the lower component 6 in the exemplary embodiment, is in the form of a laminated plastics component, in particular of a CFRP component. By contrast, in the exemplary embodiment, the upper component 4 is in the form of a metal component, in particular a steel component.

In the exemplary embodiment of FIG. 1, the two components 4, 6, in addition to the riveted connection via the blind rivet 8, are also adhesively bonded together. To this end, in particular adhesive bonding over the entire surface with the aid of a curable adhesive is provided. Therefore, an adhesive layer 10 is also formed between the two components 4, 6.

In the exemplary embodiment, the two components 4, 6 each have prepunched holes having an identical diameter. In contrast to this, it is preferably provided that the upper component 4 has a larger hole diameter so that an automated joining process of the two components 4, 6 is made easier. In particular in the case of larger components, which are fastened together via a plurality of blind rivets 8, this is advantageous in order to be able to compensate positional inaccuracies in the positioning of the two components 4, 6. The free space between the blind rivet and the widened hole diameter of the upper component 4 is in this case expediently likewise filled with adhesive.

The blind rivet 8 comprises a rivet sleeve 12 having a snap head 14 and, in the fitted state, a closing head 16. In the fitted end state, a residual mandrel of a rivet mandrel 18 having a mandrel head 20 is enclosed in the rivet sleeve.

The rivet sleeve 12 is in turn formed in a multilayer manner from an inner layer 12A and an outer layer 12B. The inner layer 12A consists in this case of a higher strength material than the outer layer 12B. In particular, the inner layer 12A consists of metal, preferably from stainless steel. The inner layer 12A itself therefore forms an independent metal sleeve. The same applies to the outer layer 12B, too, which consists of a soft material, in particular plastics material. As plastic, use is made for example of a polyamide, in particular a polyamide 4.6 or the like.

On account of this special two-layer configuration having a higher-strength inner sleeve 12A and a soft casing 12B, high forming forces and setting forces can be exerted during the setting operation. At the same time, the risk of damage, in particular delamination of the plastics component 6 is kept small or avoided. On account of the soft plastics material of the outer layer 12B, only small separating forces act on the individual laminate layers of the CFRP component 6. The outer layer 12B is therefore deformed without the CFRP component 6 being damaged.

A further advantage of the soft outer layer 12B is that sealing with respect to the two components 4, 6 takes place via this outer layer 12B. Finally, at the same time insulation from an electrical point of view is also achieved. Specifically, in the case of a hybrid connection, illustrated in FIG. 1, between a CFRP component 6 and a metal component 4, an electrically conductive connection between the two components should be avoided as far as possible.

The structure of the rivet sleeve 12 in the unset state prior to the actual fitting can be gathered from FIGS. 2a to 2c. As can be seen, the inner layer has a wall thickness d1, which is a multiple smaller than the wall thickness d2 of the outer layer. In the exemplary embodiment, the wall thickness d2 is more than 5 times greater than the wall thickness d1 of the inner layer 12A. The rivet sleeve 12 has, in addition to the snap head 14, an adjoining sleeve shank 22, which is formed in a hollow-cylindrical manner and has a constant outside diameter along its entire length.

At the shank-side end remote from the snap head 14, the inner layer 12A is widened and forms a funnel-like shank opening 24. In this case, the funnel walls extend in particular in a straight line and merge into the shank region extending parallel to the center longitudinal axis, forming a radius. The sleeve walls are in this case oriented at an angle α to a center longitudinal axis, said angle being in the region of about 45° in the exemplary embodiment and being generally in the range between 30° and 60°. The inner layer 12A is in this case guided as far as the outer circumference of the rivet sleeve 12, and there forms at the end side the circumferential periphery of the rivet sleeve 12. In a corresponding manner, the outer layer 12B has a narrowing in this funnel region, and thus tapers in a wedge-like manner. The outside diameter of the rivet sleeve remains constant in this region.

During the setting operation, the rivet mandrel 18 comes into contact with this funnel-like shank opening 24, and so the setting and forming forces are transmitted to the rivet sleeve 12 via the inner layer 12A and lead to the forming and in particular to the shaping of the closing head 16.

### LIST OF REFERENCE SIGNS

2 Joined connection
4 Steel component
6 CFRP component
8 Blind rivet
10 Adhesive layer
12 Rivet sleeve
12A Inner layer
12B Outer layer
14 Snap head
16 Closing head
18 Rivet mandrel
20 Mandrel head
22 Sleeve shank
24 Funnel-like shank opening
α Angle

1-16. (canceled)

17. A joined connection between two components, wherein at least one of the two components consists of a fiber-reinforced plastics material, comprising:
at least one blind rivet connecting the two components to one another;
said at least one blind rivet having a rivet sleeve and a rivet mandrel, said rivet sleeve being a multilayer sleeve with an inner layer made of a relatively higher-strength material and an outer layer made of a relatively lower-strength material.

18. The joined connection according to claim 17, wherein said inner layer is made of a metal.

19. The joined connection according to claim 18, wherein said inner layer is made of stainless steel.

20. The joined connection according to claim 17, wherein said outer layer consists of plastics material.

21. The joined connection according to claim 17, wherein a strength of the higher-strength material is at least 2 to 5 times greater than a strength of the lower-strength material.

22. The joined connection according to claim 17, wherein a wall thickness (d1) of said inner layer is less than a wall thickness of said outer layer.

23. The joined connection according to claim 17, wherein a wall thickness of said inner layer is less than 0.5 mm.

24. The joined connection according to claim 23, wherein a wall thickness of said inner layer is less than 0.1 mm.

25. The joined connection according to claim 17, wherein a wall thickness of said outer layer is greater than 0.5 mm.

26. The joined connection according to claim 25, wherein a wall thickness of said outer layer is greater than 1 mm.

27. The joined connection according to claim 17, wherein said outer layer is an encapsulated casing.

28. The joined connection according to claim 17, wherein said rivet sleeve includes a snap head, and said outer layer is continued on a underside of said snap head of said rivet sleeve.

29. The joined connection according to claim 17, wherein said rivet sleeve is electrically insulating with respect to the two components.

30. The joined connection according to claim 17, wherein said rivet sleeve has a shank with a shank-side end, and said inner layer of said rivet sleeve is widened at said shank-side end.

31. The joined connection according to claim 17, wherein said rivet sleeve is widened at said shank-side end without an outside diameter of said rivet sleeve being increased.

32. The joined connection according to claim 17, wherein the two components are made from mutually different materials.

33. The joined connection according to claim 17, wherein the two components are additionally adhesively bonded together.

34. The joined connection according to claim 17, wherein a diameter of said rivet mandrel is less than or equal to a wall thickness of said rivet sleeve.

35. The joined connection according to claim 17, wherein the at least two components are components for a motor vehicle and said blind rivet is engineered for use in a motor vehicle.

36. A rivet sleeve for a blind rivet, comprising a sleeve shank and a snap head, said sleeve shank being formed as a multilayer structure having an inner layer made of a higher-strength material and an outer layer made of a lower-strength material.

37. In combination with the joined connection according to claim 17, a blind rivet for the joined connection.
